(19) United States
(12) Patent Application Publication
(10) Pub. No.: US 2018/0218545 A1
(43) Pub. Date: Aug. 2, 2018

(54) VIRTUAL CONTENT SCALING WITH A HARDWARE CONTROLLER

(71) Applicant: DAQRI, LLC, Los Angeles, CA (US)

(72) Inventors: Christopher Michaels Garcia, Whittier, CA (US); Lucas Kazansky, Los Angeles, CA (US); Frank Chester Irving, JR., Woodland Hills, CA (US)

(21) Appl. No.: 15/421,320

(22) Filed: Jan. 31, 2017

(51) Int. Cl. G06T 19/20; G06T 19/00; G06F 3/0346; G06T 7/13; G06T 7/60; G06T 7/73; G09G 5/00

(52) U.S. Cl. CPC G06T 19/20; G06T 19/006; G06F 3/0346; G06T 7/13; G09G 2370/18; G06T 7/73; G09G 5/003; G06T 2215/16; G06T 7/60

(57) ABSTRACT

A head-mounted viewing device determines a first spatial location of a hardware controller relative to a spatial location of the head-mounted viewing device in a local environment, and a second spatial location of the hardware controller relative to the position of the head-mounted viewing device in the local environment, the second spatial location being different than the first spatial location. The head-mounted viewing device determines, based on at least the first spatial location and the second spatial location, a spatial boundary within the local environment relative to the spatial location of the head-mounted viewing device, and causes presentation of the virtual content on a transparent display of the head-mounted viewing device based on the spatial boundary such that the virtual content appears to be present within the spatial boundary of the local environment to a user wearing the head-mounted viewing device.

### BACKGROUND

The subject matter disclosed herein generally relates to presenting virtual content to augment reality. Specifically, the present disclosure addresses systems and methods for scaling presentation of virtual content using a hardware controller.

Augmented reality (AR) systems present virtual content to augment a user's reality. Virtual content overlaid over a physical object can create the illusion that the physical object is moving, animated, etc. For example, virtual content presented over a physical object can create the illusion that the physical object is changing colors, emitting light, etc. For the illusion to be convincing, however, presentation of the virtual content should be aligned as closely as possible with the physical object. For example, a size of the virtual content should be scaled appropriately to align with the size of the physical object when viewed by the user. Likewise, the virtual content should be presented at an appropriate position such that the virtual content aligns with the physical object when viewed by the user. Properly aligning virtual content with a physical object can be problematic.

BRIEF DESCRIPTION OF THE SEVERAL VIEWS OF THE DRAWINGS

To easily identify the discussion of any particular element or act, the most significant digit or digits in a reference number refer to the figure number in which that element is first introduced.

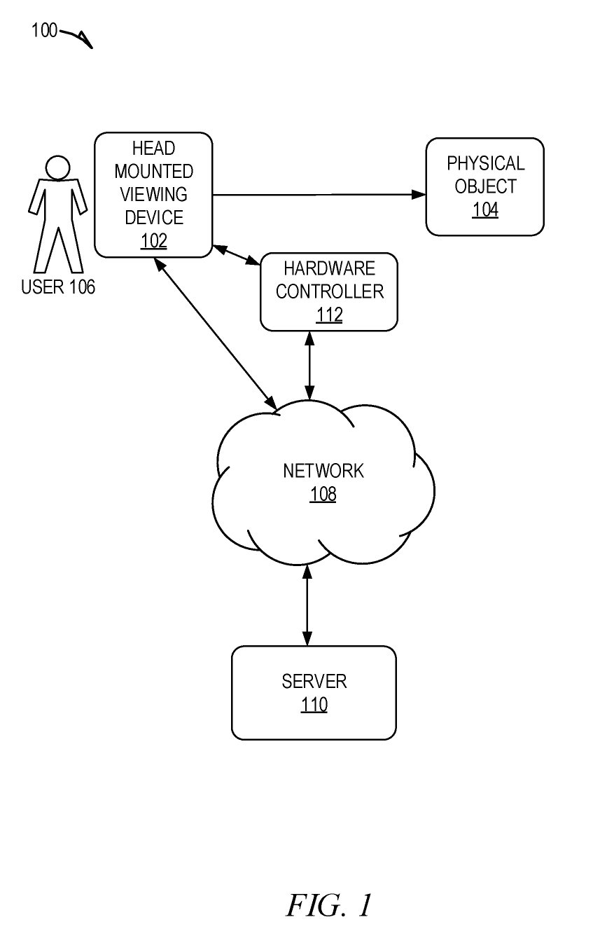

FIG. 1 is a block diagram illustrating an example of a network environment suitable for presenting virtual content to augment a user's reality, according to some example embodiments.

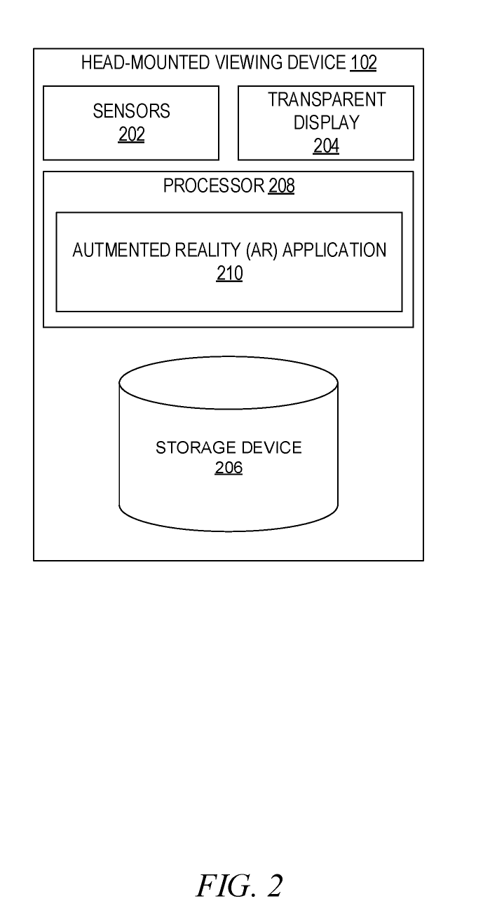

FIG. 2 is a block diagram illustrating an example embodiment of a head-mounted viewing device, according to some embodiments.

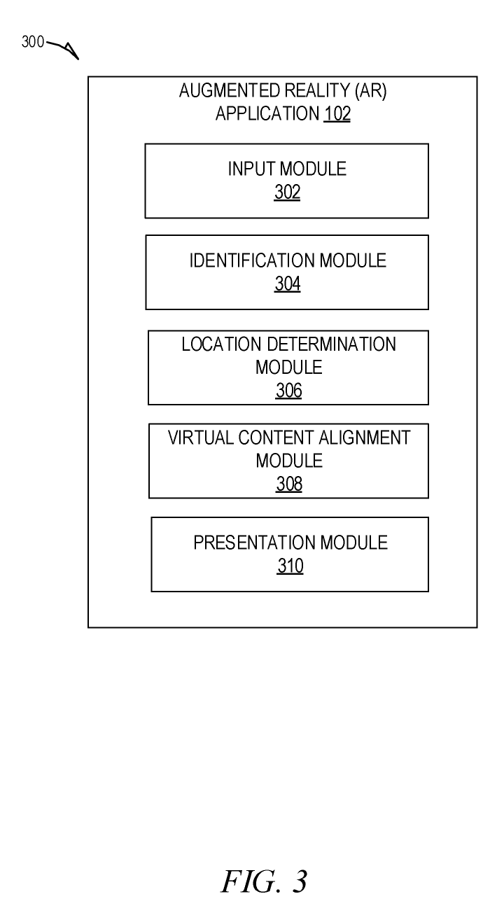

FIG. 3 is a block diagram illustrating an example embodiment of an augmented reality application, according to some embodiments.

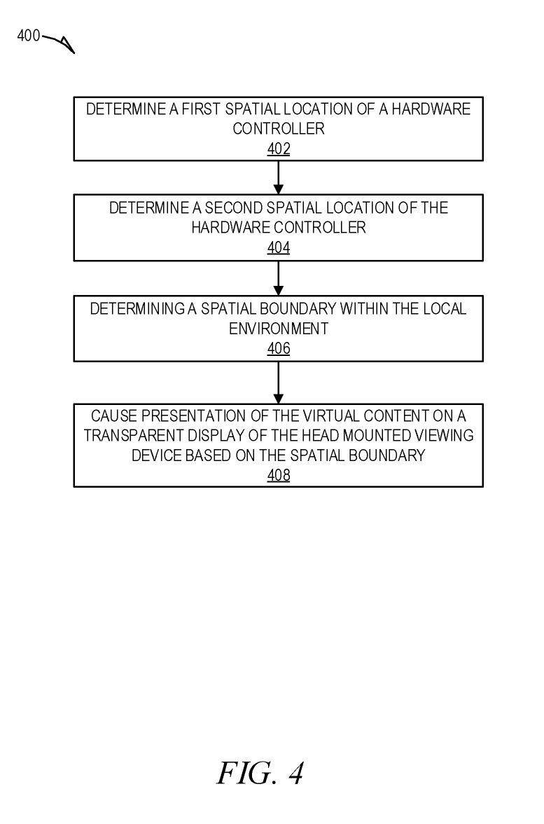

FIG. 4 is an example method for scaling presentation of virtual content using a hardware controller, according to some example embodiments.

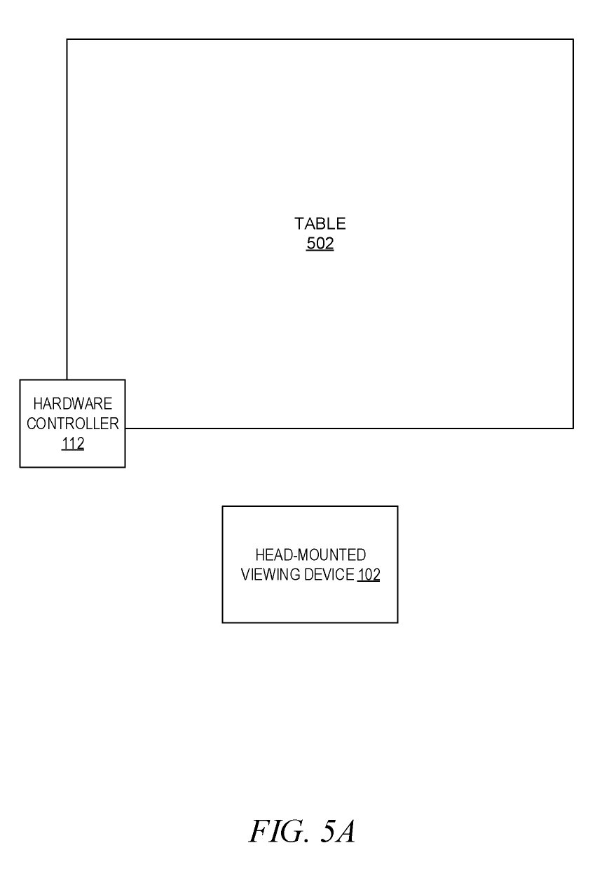

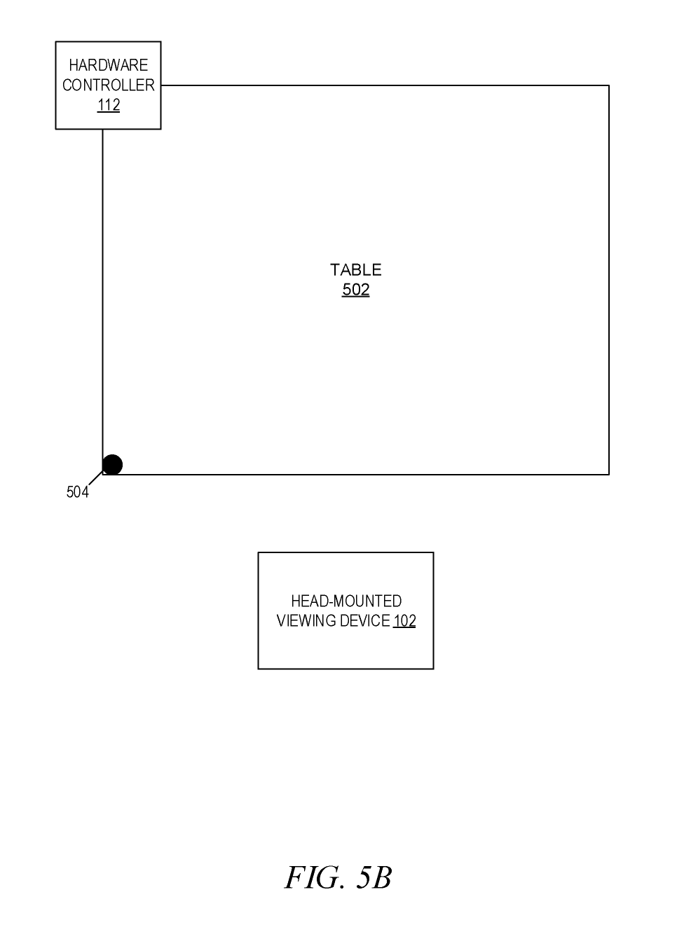

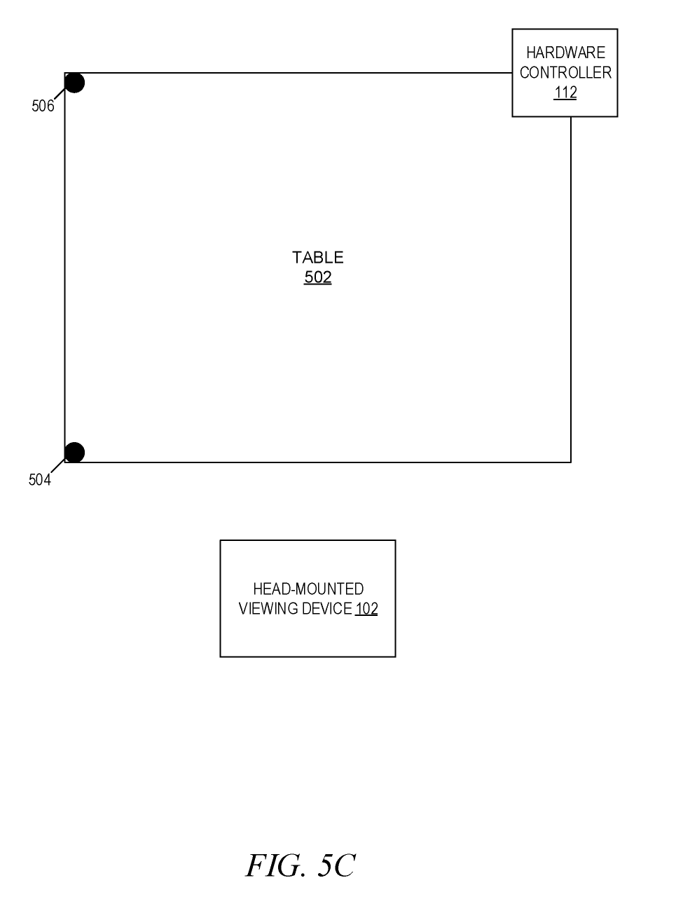

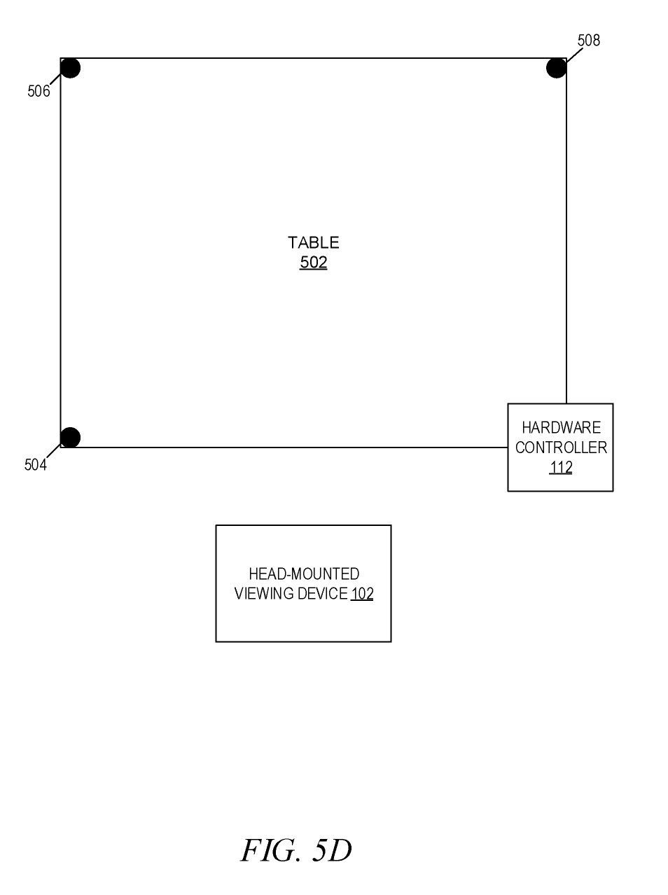

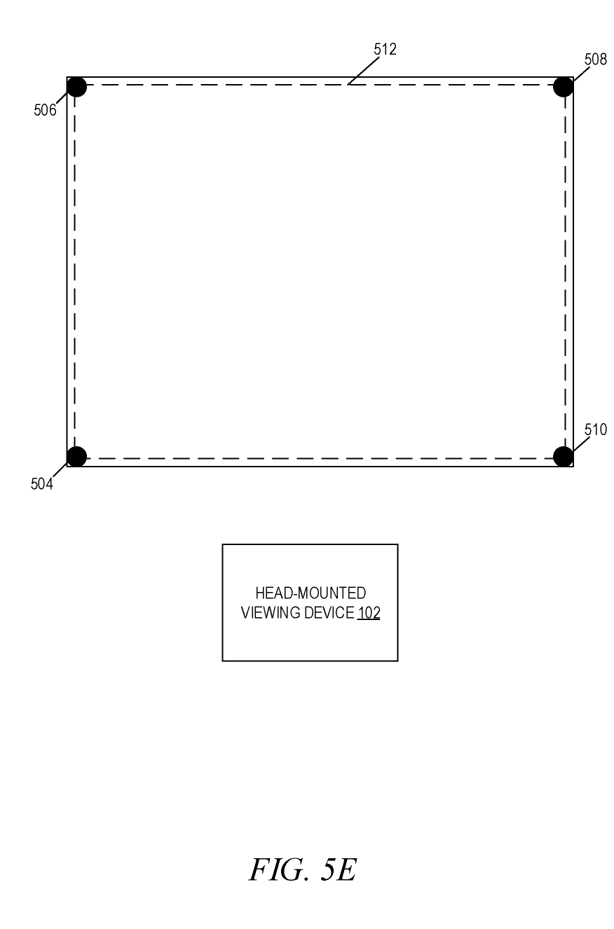

FIGS. 5A-5E illustrate scaling presentation of virtual content using a hardware controller, according to some example embodiments.

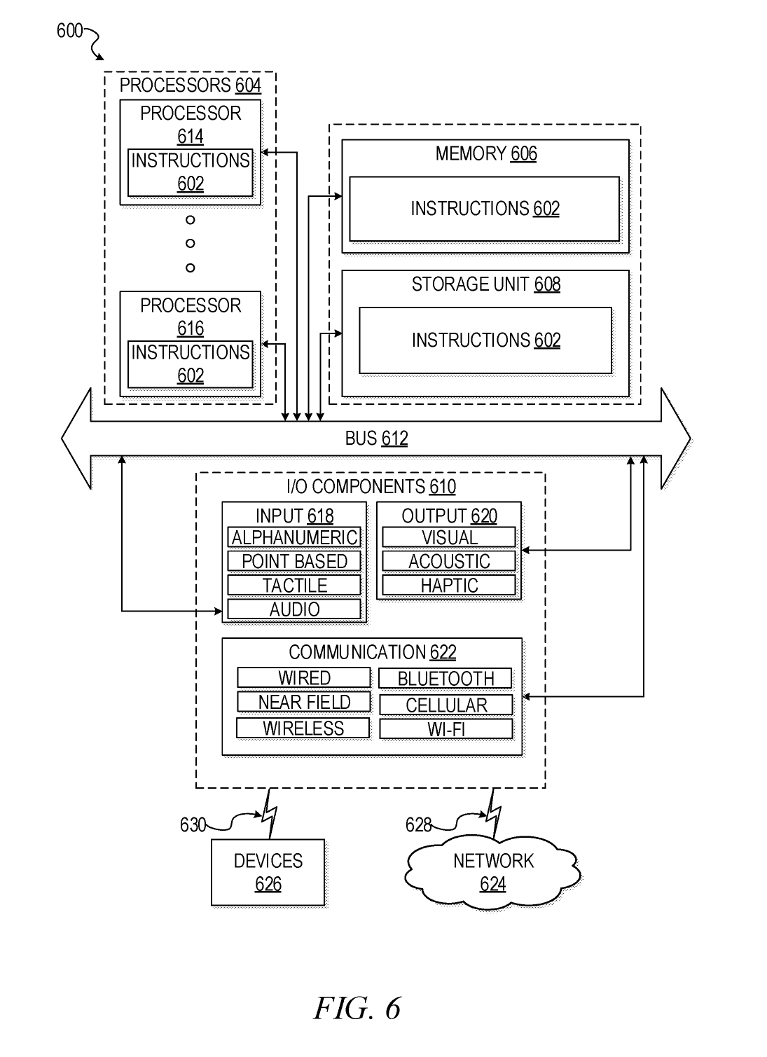

FIG. 6 is a diagrammatic representation of a computing device in the example form of a computer system within which a set of instructions for causing the computing device to perform any one or more of the methodologies discussed herein may be executed.

### DETAILED DESCRIPTION

Example methods and systems are directed to scaling presentation of virtual content using a hardware controller for augmented reality systems. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Augmented reality (AR) systems allow a user to augment reality with virtual content. Virtual content can be overlaid on an image of a real-world physical object to augment a user's a reality by creating the illusion that the real-world physical object is, for example, changing colors, emitting lights, etc. For example, virtual content can be overlaid over a table to create the illusion that a chess-board is present on the table. As another example, virtual content can be overlaid over a block pyramid to create the illusion that the pyramid is changing colors or emitting lights.

To accomplish this, a user can utilize a viewing device capable of capturing an image of a real-world physical object and presenting virtual content over the real-world physical object. For example, a viewing device can be a handheld device such as a tablet or smartphone capable of capturing an image of a real world object and presenting virtual content over the image of the real-world object on a display of the viewing device.

As another example, a viewing device can be a wearable device such as a head-mounted viewing device (e.g., helmet, glasses). A head-mounted viewing device can include a transparent or clear display (e.g., see-through display) that allows a user to simultaneously view virtual content presented on the display and real-world physical objects that are visible through the display. A head-mounted viewing device can present virtual content on its display such that the virtual content appears to be overlaid over a real-world physical object that is visible through the display to a user wearing the head-mounted viewing device.

To properly create the illusion of augmented reality in relation to a real-world physical object, the head-mounted viewing device can present the virtual content on the display such that the dimensions of the virtual content align closely to the dimensions of the real-world physical object as perceived by a user wearing the head-mounted viewing device. For example, the head-mounted viewing device can scale a presentation size of the virtual content to match the size of the real-world physical object as viewed by the user. The head-mounted viewing device can also present the virtual content at a position on the display of the head-mounted viewing device such that the virtual content appears to overlay the real-world physical object to a user wearing the head-mounted viewing device.

A hardware controller can be used to properly align virtual content with a real-world physical object. A hardware controller can be any type of hardware device configured to emit a signal that can be received or captured by a head-mounted viewing device. For example, a hardware controller can be a mobile computing device (e.g., smartphone) or a head-mounted viewing device specific device (e.g., remote designed for the head-mounted viewing device).

To properly align virtual content with a real-world physical object, a user can place the hardware controller at one or more strategic positions in relation to the real-world object, and the head-mounted viewing device can determine a spatial location of the hardware controller at each position in relation to a spatial location of the head-mounted viewing device. For example, to properly align virtual content with a square table, the user can place the hardware controller on each corner of the table.

The head-mounted viewing device can use the determined spatial locations of the hardware controller to determine a spatial boundary within the user's local environment. The head-mounted viewing device can then cause presentation of the virtual content on the display of the head-mounted viewing device based on the spatial boundary such that the virtual content appears to be present within the spatial boundary of the local environment to the user wearing the head-mounted viewing device. For example, the head-mounted viewing device can determine a presentation size and a presentation position of the virtual content based on the spatial boundary.

FIG. 1 is a block diagram illustrating an example of a network environment suitable for presenting virtual content to augment a user's reality, according to some example embodiments. The network environment 100 includes a head-mounted viewing device 102 and a server 110, communicatively coupled to each other via a network 108. The head-mounted viewing device 102 and the server 110 may each be implemented in a computer system, in whole or in part, as described below with respect to FIG. 5.

The server 110 may be part of a network-based system. For example, the network-based system may be or include a cloud-based server system that provides additional information, such as three-dimensional (3D) models or other virtual content, to the head-mounted viewing device 102.

The head-mounted viewing device 102 can be used by the user 106 to augment the user's reality. The user 106 may be a human user (e.g., a human being), a machine user (e.g., a computer configured by a software program to interact with the head-mounted viewing device 102), or any suitable combination thereof (e.g., a human assisted by a machine or a machine supervised by a human). The user 106 is not part of the network environment 100, but is associated with the head-mounted viewing device 102.

The head-mounted viewing device 102 may be a computing device with a camera and a transparent display, such as a tablet, smartphone, or a wearable computing device (e.g., helmet or glasses). In another example embodiment, the computing device may be hand held or may be removably mounted to the head of the user 106 (e.g., head-mounted viewing device).

In one example, the display may be a screen that displays what is captured with a camera of the head-mounted viewing device 102. In another example, the display of the head-mounted viewing device 102 may be transparent or semi-transparent, such as in lenses of wearable computing glasses or the visor or a face shield of a helmet. In this type of embodiment, the user 106 may simultaneously view virtual content presented on the display of the head-mounted viewing device 102 as well as a physical object 104 in the user's 106 line of sight in the real-world physical environment.

The head-mounted viewing device 102 may provide the user 106 with an augmented reality experience. For example, the head-mounted viewing device can present virtual content on the display of the head-mounted viewing device that the user 106 can view in addition to physical objects 104 that are in the line of sight of the user in the real-world physical environment. Virtual content can be any type of image, animation, etc., presented on the display.

The head-mounted viewing device 102 can present virtual content on the display to augment a physical object 104. For example, the head-mounted viewing device 102 can present virtual content to create an illusion to the user 106 that the physical object 104 is changing colors, emitting lights, etc. As another example, the head-mounted viewing device 102 can present virtual content on a physical object 104 such as a table to create the illusion to the user 106 that a chess board is present on the table.

The physical object 104 may include any type of identifiable objects such as a 2D physical object (e.g., a picture), a 3D physical object (e.g., a factory machine, table, cube, etc.), a location (e.g., at the bottom floor of a factory), or any references (e.g., perceived corners of walls or furniture) in the real-world physical environment.

The head-mounted viewing device 102 can present virtual content in response to detecting one or more identified objects (e.g., physical object 104) in the physical environment. For example, the head-mounted viewing device 102 may include optical sensors to capture images of the real-world physical environment and computer vision recognition to identify physical objects 104.

In one example embodiment, the head-mounted viewing device 102 locally analyzes captured images using a local content dataset or any other dataset previously stored by the head-mounted viewing device 102. The local content dataset may include a library of virtual content associated with real-world physical objects 104 or references. For example, the local content dataset can include image data depicting real-world physical objects 104, as well as metadata describing the real-world objects. The head-mounted viewing device can utilize the captured image of a physical object to search the local content dataset to identify the physical object and its corresponding virtual content.

In one example, the head-mounted viewing device 102 can analyze an image of a physical object 104 to identify feature points of the physical object. The head-mounted viewing device 102 can utilize the identified feature points to identify a corresponding real-world physical object from the local content dataset. The head-mounted viewing device 102 may also identify tracking data related to the physical object 104 (e.g., GPS location of the head-mounted viewing device 102, orientation, distance to the physical object 104).

If the captured image is not recognized locally by the head-mounted viewing device 102, the head-mounted viewing device 102 can download additional information (e.g., virtual content) corresponding to the captured image, from a database of the server 110 over the network 108.

In another example embodiment, the physical object 104 in the image is tracked and recognized remotely at the server 110 using a remote dataset or any other previously stored dataset of the server 110. The remote content dataset may include a library of virtual content or augmented information associated with real-world physical objects 104 or references. In this type of embodiment, the head-mounted viewing device 102 can provide the server with the captured image of the physical object 104. The server 110 can use the received image to identify the physical object 104 and its corresponding virtual content. The server 110 can then return the virtual content to the head-mounted viewing device 102.

The head-mounted viewing device 102 can present the virtual content on the display of the head-mounted viewing device 102 to augment the user's 106 reality. For example, the head-mounted viewing device 102 can present the virtual content on the display of the head-mounted viewing device 102 to allow the user to simultaneously view the virtual content as well as the real-world physical environment in the line of sight of the user.

In some embodiments, the virtual content associated with a physical object 104 can be intended to augment the physical object 104. For example, the virtual content can be presented to create the illusion that the physical object 104 is changing colors, emitting light, includes animations, etc. In this type of embodiment, aligning presentation of the virtual content with the physical object 104 is important to properly create the illusion. For example, to augment a physical object 104, such as a block pyramid, with virtual content of a light emitting from the tip of the pyramid, presentation of the virtual content should be closely aligned to properly create the illusion to the user 106. If the virtual content is not properly aligned, the light might appear to be emitting from a point other than the tip of the pyramid, thereby ruining the impact of the illusion for the user.

A hardware controller 112 can be used to assist the head-mounted viewing device 102 with properly aligning presentation of virtual content with a physical object. A hardware controller 112 can be any type of hardware device configured to emit a signal that can be received or captured by the head-mounted viewing device 102. For example, a hardware controller 112 can be a mobile computing device, such as a smartphone or a head-mounted viewing device specific device.

To properly align virtual content with a real-world physical object, a user can place the hardware controller 112 at one or more strategic positions in relation to the physical object 104, and the head-mounted viewing device 102 can determine a spatial location of the hardware controller 112 at each position in relation to a spatial location of the head-mounted viewing device 102. The spatial location of the hardware controller 112 in relation to the head-mounted viewing device 102 can include a distance, direction, etc., of the hardware controller 112 from the head-mounted viewing device 102. In some embodiments, the spatial location of the hardware controller 112 is determined in related to another device besides the head-mounted device 102, such as a fixed or predefined reference device in the user's real world environment (e.g., within the same room as the head-mounted device 102). For example, the spatial location of the hardware controller 112 can be determined in relation to a base station (not shown) or other computing device located in the user's real-world environment.

Strategic positions in relation to the physical object 104 can be selected by the user 106 based on the physical object 104 and/or a position at which the user 106 would like the virtual content presented. For example, to align virtual content with the top a square table, the user 106 can place the hardware controller 112 on each corner of the table. Alternatively, if the user 106 desires to align the virtual content within a smaller boundary on the table top, the user 106 can place the hardware controller at points on the table to designate the desired corners for presenting the virtual content.

The head-mounted viewing device 102 can determine the spatial location of the hardware controller 112 at each location. The head-mounted viewing device 102 can use the determined spatial locations of the hardware controller 112 to determine a spatial boundary within the user's local environment. The head-mounted viewing device 102 can then cause presentation of the virtual content on the display of the head-mounted viewing device 112 based on the spatial boundary such that the virtual content appears to present within the spatial boundary (e.g., on the table) of the local environment to the user 106. For example, the head-mounted viewing device 112 can determine a presentation size and a presentation position of the virtual content based on the spatial boundary and then cause presentation of the virtual content based according to the determined presentation size and presentation position.

As the user moves (e.g., changes position and orientation in relation to the physical object 104) the head-mounted viewing device 102 can adjust the presentation of the virtual content to cause the virtual content to remain aligned with the physical object. For example, the head-mounted viewing device 102 can adjust the presentation size and presentation position of the virtual content such that the virtual content remains aligned with the physical object 104 to the user 106. To accomplish this, the head-mounted viewing device 102 can utilize the spatial boundary in relation to the head-mounted viewing device 102 as an initial reference position. As the head-mounted viewing device 102 detects that the head-mounted viewing device has changed positions (e.g., detected movements by an accelerometer), the head-mounted viewing device 102 can determined an updated position in relation to the spatial boundary and adjust presentation of the virtual content accordingly such that the virtual content remains present within the spatial boundary to the user 106.

Although only one head-mounted viewing device 102 and one hardware controller 112 are shown in FIG. 1, this is only for ease of explanation and is not meant to be limiting. The network environment can include any number of head-mounted viewing devices 102 and hardware controller 112. For example, head-mounted viewing device 102 can determined the spatial locations of multiple hardware controllers 112, which can be used to determine a spatial boundary.

Likewise, a hardware controller 112 can be used with multiple head-mounted viewing devices 102. For example, two or more head-mounted viewing devices 102 can determine the spatial locations of the hardware controller 112 relative to the respective head-mounted viewing device 102. The head-mounted viewing devices 102 can use the determined spatial locations to determine spatial boundaries relative to the respective head-mounted viewing device 102.

In some embodiments, a head-mounted viewing device 102 can provide the determined spatial locations of the hardware controller and/or the determined spatial boundary to another head-mounted viewing 102. The other head-mounted viewing device can then use the received spatial locations and/or spatial boundary to properly align presentation of virtual content with a physical object 104.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 20. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 110), databases, and devices (e.g., head-mounted viewing device 102). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

FIG. 2 is a block diagram illustrating an example embodiment of a head-mounted viewing device 102, according to some embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the head-mounted viewing device 103 to facilitate additional functionality that is not specifically described herein. Furthermore, the various functional modules depicted in FIG. 2 may reside on a single computing device or may be distributed across several computing devices in various arrangements such as those used in cloud-based architectures.

The head-mounted viewing device 102 includes sensors 202, a transparent display 204, a computer processor 208, and a storage device 206. The head-mounted viewing device 102 can include a helmet, a visor, or any other device that can be mounted to the head of a user 106.

The sensors 202 can include any type of known sensors. For example, the sensors 202 can include a thermometer, an infrared camera, a barometer, a humidity sensor, an electroencephalogram (EEG) sensor, a proximity or location sensor (e.g., near field communication, GPS, Bluetooth, Wi-Fi), an optical sensor (e.g., camera), an orientation sensor (e.g., gyroscope), an audio sensor (e.g., a microphone), or any suitable combination thereof. For example, the sensors 202 may include a rear-facing camera and a front-facing camera in the head-mounted viewing device 102. It is noted that the sensors described herein are for illustration purposes and the sensors 202 are thus not limited to the ones described.

The transparent display 204 includes, for example, a display configured to display virtual images generated by the processor 208. In another example, the transparent display 204 includes a touch-sensitive surface to receive a user input via a contact on the touch-sensitive surface. The transparent display 204 can be positioned on the head-mounted viewing device 102 such that the user 106 can simultaneously view virtual content presented on the transparent display and a physical object 104 in a line-of-sight of the user 106.

The processor 208 includes an AR application 210 configured to present virtual content on the transparent display 204 to augment the user's 104 reality. The AR application 210 can receive data from sensors 202 (e.g., an image of the physical object 104, location data, etc.), and use the received data to identify a physical object 104 and present virtual content on the transparent display 204.

To identify a physical object 104, the AR application 210 can determine whether an image captured by the head-mounted viewing device 102 matches an image locally stored by the head-mounted viewing device 102 in the storage device 206. The storage device 206 can include a local content dataset of images and corresponding virtual content. For example, the head-mounted viewing device 102 can receive a content data set from the server 110, and store the received content data set in the storage device 206.

The AR application 210 can compare a captured image of the physical object 104 to the images locally stored in the storage device 206 to identify the physical object 104. For example, the AR application 210 can analyze the captured image of a physical object 104 to identify feature points of the physical object. The AR application 210 can utilize the identified feature points to identify physical object 104 from the local content dataset.

In some embodiments, the AR application 210 can identify a physical object 104 based on a detected visual reference (e.g., a logo or QR code) on the physical object 104 (e.g., a chair). The visual reference may also be referred to as a marker and may consist of an identifiable image, symbol, letter, number, machine-readable code. For example, the visual reference may include a bar code, a quick response (QR) code, or an image that has been previously associated with the virtual content.

If the AR application 210 cannot identify a matching image from the local content dataset, the AR application 210 can provide the captured image of the physical object 104 to the server 110 to search a remote content dataset maintained by the server 110.

The remote content dataset maintained by the server 110 can be larger than the local content dataset maintained by the head-mounted viewing device 102. For example, the local content dataset maintained by the head-mounted viewing device 102 can include a subset of the data maintained by the remote content dataset, such as a core set of images of the most popular images determined by the server 110.

Once the physical object 104 has been identified by either the head-mounted viewing device 102 or the server 110, the corresponding virtual content can be retrieved and presented on the transparent display 204 to augment the user's 106 reality. The AR application 210 can present the virtual content on the transparent display 204 to create an illusion to the user 106 that the virtual content is in the user's real world, rather than virtual content presented on the display. For example, the AR application 210 can present the virtual content at a presentation position and a presentation size to properly align the virtual content with the physical object 104 as viewed by the user 106.

The presentation position can be a position on the transparent display at which the virtual content is presented, as well as an orientation of the virtual content when presented. The presentation size can be a size at which the virtual content is presented. The AR application 210 can adjust the presentation position and presentation size of the virtual content to create the illusion to the user that the virtual content is presented in the user's 106 real world environment. For example, the AR application 210 can increase the presentation size of the virtual content as the user 106 moves forward, thereby creating the illusion that the user 106 is moving closer to the virtual content. Similarly, the AR application 210 can decrease the presentation size of the virtual content as the user 106 moves back, thereby creating the illusion that the user 106 is moving away from the virtual content.

The AR application 210 can also vary the presentation position of the virtual content based on the user's 106 movements. For example, as the user 106 moves his head to the left, the AR application 210 can adjust the presentation position of the virtual content to the user's 106 right, thereby creating the illusion that the virtual content remains in it presented physical location as the user 106 moves. Likewise, as the user 106 moves his head to the right, the AR application 210 can adjust the presentation position of the virtual content to the user's 106 left.

The head-mounted viewing device 102 can utilize a hardware controller 112 to properly align presentation of virtual content with the user's real-world physical environment, such as with a specific physical object 104 in the user's 106 real-world physical environment. The hardware controller 112 can be any type of hardware device configured to emit a signal that can be received or captured by the head-mounted viewing device 102. For example, a hardware controller 112 can be a mobile computing device, such as a smartphone or a head-mounted viewing device specific device.

To properly align virtual content with a real-world physical object, a user can place the hardware controller 112 at one or more strategic positions in relation to the physical object 104, and the AR application 210 can determine a spatial location of the hardware controller 112 at each position in relation to a spatial location of the head-mounted viewing device 102. The spatial location of the hardware controller 112 in relation to the head-mounted viewing device 102 can include a distance, direction, etc., of the hardware controller 112 from the head-mounted viewing device 102.

The AR application 210 can determine the spatial location of the hardware controller 112 at each location. The AR application 210 can determine the spatial location of the hardware controller 112 utilizing sensor data received from sensors 202. For example, sensors 202 can capture signals transmitted by the hardware controller 112 (e.g., Infrared LED, wireless signal, etc.) and the AR application 210 can utilize the signal to determine the spatial location of the hardware controller 112 in relation to the head-mounted viewing device 102. For example, the AR application 210 can utilize a signal strength and angle at which the signal was received to determine a relative distance and direction of the hardware controller 112 in relation to the head-mounted viewing device 102.

In some embodiments, the AR application 210 can determined the spatial location of the hardware controller 112 based on data received from the hardware controller 112. For example, the hardware controller 112 can transmit location data to the head-mounted viewing device 102 that identifies the location of the hardware controller. The location data can include data gathered by the hardware controller 112, such as data gathered by a GPS component, gyroscope, etc. The AR application 210 can use the received location data to determine the spatial position of the hardware controller.

The AR application 210 can use the determined spatial locations of the hardware controller 112 to determine a spatial boundary within the user's local environment. The AR application 210 can then cause presentation of the virtual content on the transparent display 204 based on the spatial boundary such that the virtual content appears to be present within the spatial boundary (e.g., on the table) of the local environment to the user 106. For example, the AR application 210 can determine a presentation size and a presentation position of the virtual content based on the spatial boundary and then cause presentation of the virtual content based according to the determined presentation size and presentation position.

As the user moves (e.g., changes position and orientation in relation to the physical object 104) the AR application 210 can adjust the presentation of the virtual content to cause the virtual content to remain aligned with the physical object 104. For example, the AR application 210 can adjust the presentation size and presentation position of the virtual content such that the virtual content remains aligned with the physical object 104 to the user 106.

The network 108 may be any network that enables communication between or among machines, databases, and devices (e.g., the head-mounted viewing device 102). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

FIG. 3 is a block diagram illustrating an example embodiment of an AR application 210, according to some embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by query manager 120 to facilitate additional functionality that is not specifically described herein. Furthermore, the various functional modules depicted in FIG. 2 may reside on a single computing device or may be distributed across several computing devices in various arrangements such as those used in cloud-based architectures.

As shown, AR application 210 includes input module 302, identification module 304, location determination module 306, virtual content alignment module 308 and presentation module 310.

The input module 302 can receive data from sensors 202 (e.g., an image of the physical object 104, location data, etc.) and a hardware controller 112 (e.g., location data). The input module 302 can provide the received data to any of the other modules included in the AR application 210.

The identification module 304 can identify a physical object 104 and corresponding virtual content based on an image of the physical object 104 captured by sensors 202 of the head-mounted viewing device 102. For example, the identification module 304 can determine whether the captured image matches or is similar to an image locally stored by the head-mounted viewing device 102 in the storage device 206.

The identification module 304 can compare a captured image of the physical object 104 to a local content dataset of images locally stored in the storage device 206 to identify the physical object 104. For example, the identification module 304 can analyze the captured image of a physical object 104 to identify feature points of the physical object. The identification module 304 can utilize the identified feature points to identify the physical object 104 from the local content dataset.

In some embodiments, the identification module 304 can identify a physical object 104 based on a detected visual reference (e.g., a logo or QR code) on the physical object 104 (e.g., a chair). The visual reference may also be referred to as a marker and may consist of an identifiable image, symbol, letter, number, machine-readable code. For example, the visual reference may include a bar code, a quick response (QR) code, or an image that has been previously associated with the virtual content. The local content dataset can include a listing of visual references and corresponding virtual content. The identification module 304 can compare visual references detected in a captured image to the visual references include in the local content dataset.

If the identification module 304 cannot identify a matching image from the local content dataset, the identification module 304 can provide the captured image of the physical object 104 to the server 110 and the server 110 can search a remote content dataset maintained by the server 110.

Once the physical object 104 has been identified, the identification module 304 can access the corresponding virtual content to be presented on the transparent display 204 to augment the user's 106 reality.

The location determination module 306 can utilize the hardware controller 112 to properly align presentation of virtual content with the user's real-world physical environment, such as with a specific physical object 104 in the user's 106 real-world physical environment.

To properly align virtual content with a real-world physical object, a user 106 can place the hardware controller 112 at one or more strategic positions in relation to the physical object 104. The location determination module 306 can determine a spatial location of the hardware controller 112 at each position in relation to a spatial location of the head-mounted viewing device 102. The spatial location of the hardware controller 112 in relation to the head-mounted viewing device 102 can include a distance, direction, etc., of the hardware controller 112 from the head-mounted viewing device 102.

The location determination module 306 can determine the spatial location of the hardware controller 112 at each location utilizing sensor data received from sensors 202. Sensors 202 can capture signals transmitted by the hardware controller 112 and the location determination module 306 can utilize the signals to determine the spatial location of the hardware controller 112 in relation to the head-mounted viewing device 102. For example, the hardware controller 112 can include an infrared light-emitting diode (IR LED), and the sensors 202 can capture an infrared signal transmitted by the IR LED. The location determination module 306 can utilize a signal strength and angle at which the signal was received to determine a relative distance and direction of the hardware controller 112 in relation to the head-mounted viewing device 102.

In some embodiments, the location determination module 306 can determine the spatial location of the hardware controller 112 based on data received from the hardware controller 112. For example, the hardware controller 112 can transmit location data to the head-mounted viewing device 102 that identifies the location of the hardware controller. The location data can include data gathered by the hardware controller 112, such as data gathered by a GPS component, gyroscope, etc. In some embodiments, the hardware controller 112 can include an optical sensor (e.g., camera) and utilize VIO to determine its position. The location determination module 306 can use the received location data to determine the spatial position of the hardware controller.

The location determination module 306 can use the determined spatial locations of the hardware controller 112 to determine a spatial boundary within the user's local environment. The spatial boundary can indicate a physical area in the user's 106 physical environment relative to the head-mounted viewing device 102 in which the virtual content should appear to be physically located. The spatial boundary can indicate a distance, direction and size of the spatial boundary in reference to the head-mounted viewing device 102.

The virtual content alignment module 308 can generate the virtual content based on the determined spatial boundary. For example, the virtual content alignment module 308 can determine a presentation size and presentation position for the virtual content based on the spatial boundary in relation to the head-mounted viewing device 102 to create the illusion to the user 106 that the virtual content is present within the spatial boundary. For example, the virtual content alignment module 308 can utilize the determined distance and size of the spatial boundary in relation to the head-mounted viewing device 102 to determine the presentation size of the virtual content. Likewise, the virtual content alignment module 308 can use the direction of the spatial boundary relative to the head-mounted viewing device 102 to determine the presentation position of the virtual content.

The virtual content alignment module 308 can detect movements of the head-mounted viewing device 102 and continuously update the virtual content to maintain the perceived position of the virtual content within the spatial boundary. For example, the virtual content alignment module 308 can update the presentation position and presentation size of the virtual content based on the detected movements. As a result, the virtual content alignment module 308 can increase the presentation size of the virtual content upon detecting that the user 106 has moved close to the physical object 104. Likewise, the virtual content alignment module 308 can decrease the presentation size of the virtual content upon detecting that the user 106 has moved away from the physical object 104.

The virtual content alignment module 308 can further adjust the presentation position and presentation size of the virtual content based on user input. For example, the user 106 can utilize the hardware controller 112 to provide inputs indicating a direction in which the virtual content should be adjusted to properly align the virtual content with a physical object 104. In response the virtual content alignment module 308 can adjust the presentation of the

The presentation module 310 can present the virtual content on the transparent display 204 according to the presentation size and presentation position. This can create the illusion to the user 106 that the virtual content is in physically present with the spatial boundary of the user's 106 real world environment. For example, the virtual content is adjusted or scaled to map the spatial boundary.

FIG. 4 is an example method 400 for scaling presentation of virtual content using a hardware controller 112, according to some example embodiments. Method 400 may be embodied in computer readable instructions for execution by one or more processors such that the operations of method 400 may be performed in part or in whole by AR application 210; accordingly, method 400 is described below by way of example with reference thereto. However, it shall be appreciated that at least some of the operations of method 400 may be deployed on various other hardware configurations and method 400 is not intended to be limited to AR application 210.

At operation 402, the identification module 304 determines a first spatial location of a hardware controller relative to a spatial location of the head-mounted viewing device 102 in a local environment. In some embodiments, the identification module 304 receives, from the hardware controller 112, location data gathered by sensors of the hardware controller 112, and determines the first spatial location of the hardware controller 112 based on the location data received from the hardware controller 112. In some embodiments, the identification module 304 receives an infrared signal transmitted by an infrared light-emitting diode (IR LED) located on the hardware controller 112, and determines the first spatial location of the hardware controller 112 based on the infrared signal. As another example, the identification module 304 can analyze an image of the hardware controller captured by an optical sensor (e.g., camera) and track high contrast points on the hardware controller 112 to determine the first spatial location.

At operation 404, the identification module 304 determines a second spatial location of the hardware controller 112 relative to the position of the head-mounted viewing device 102 in the local environment. The second spatial location can be different than the first spatial location. For example, the user 106 can place the hardware controller 112 at various strategic positions in relation to a physical object 104. Although only two spatial locations of the hardware controller are discussed in relation to method 400, this is only one example and is not meant to be limiting. Any number of spatial locations of the hardware controller 112 can be determined and this disclosure anticipates all such embodiments.

At operation 406, the identification module 304 determines, based on at least the first spatial location and the second spatial location, a spatial boundary within the local environment relative to the spatial location of the head-mounted viewing device 102.

At operation 408, the presentation module 310 causes presentation of the virtual content on a transparent display 204 of the head-mounted viewing device 102 based on the spatial boundary. For example, the virtual content can be presented such that the virtual content appears to be present within the spatial boundary of the local environment to the user 106 wearing the head-mounted viewing device 102.

To properly align the virtual content with the spatial boundary, the virtual content alignment module 306 can determine a presentation size of the virtual content and a presentation position of the virtual content on the transparent display 204 of the head-mounted viewing device 102 based on the spatial boundary. The virtual content alignment module 306 generates the virtual content according to the presentation size and the presentation module 310 then presents the virtual content on the display of the head-mounted viewing device according to the presentation position.

In response to detecting that the spatial location of the head-mounted viewing device 102 has changed, the presentation module 310 can update presentation of the virtual content on the transparent display 204 of the head-mounted viewing device 102 such that the virtual content appears to remain present within the spatial boundary of the local environment to the user 106 wearing the head-mounted viewing device 102. For example, the virtual content alignment module 306 can modify one or more of a presentation size of the virtual content or a presentation position of the virtual content on the transparent display 204 and the transparent display 204 can present the virtual content based on the modified presentation size and/or presentation position.

After causing presentation of the virtual content on the transparent display 204 of the head-mounted viewing device 112, the virtual content alignment module 306 can receive an input from the hardware controller 112 indicating a direction in which to adjust presentation of the virtual content. For example, the input can indicate that presentation of the virtual content should be adjusted to the left, right, forward, backwards, etc., to properly align the virtual content with a physical object 104. The virtual content alignment module 306 can update presentation of the virtual content on the transparent display 204 based on the received input.

In some embodiments, the head-mounted viewing device 112 can include one or more user input elements (e.g., buttons). In this type of embodiment, the user 116 can use the user input elements to indicate a direction in which to adjust presentation of the virtual content rather than using the hardware controller 112.

FIGS. 5A-5D illustrate scaling presentation of virtual content using a hardware controller, according to some example embodiments. A user of a head-mounted viewing device 102 can utilize a hardware controller 112 to align presentation of virtual content with a table 502 present in the user's real-world environment. As shown, the user has placed the hardware controller 112 at a first corner of the table 502. The head-mounted viewing device 102 can determine the spatial location of the hardware controller 112 at the first corner of the table 502. The spatial location of the hardware controller 112 can indicate the spatial location of the hardware controller 112 in relation to the head-mounted viewing device 102 or, alternatively, relative to another device present in the user's real world environment.

As shown in FIGS. 5B-5D, the user can place the hardware controller 112 at the other corners of the table 112 to determine the spatial location of the hardware controller 112 at each additional corner. As shown, in FIG. 5E, the determined spatial location at each corner 504, 506, 508 and 501, can be used to determine a spatial boundary 512 for presenting virtual content.

FIG. 6 is a block diagram illustrating components of a computing device 600, according to some example embodiments, able to read instructions from a machine-readable medium (e.g., a machine-readable storage medium) and perform any one or more of the methodologies discussed herein. Specifically, FIG. 6 shows a diagrammatic representation of computing device 600 in the example form of a system, within which instructions 602 (e.g., software, a program, an application, an applet, an app, a driver, or other executable code) for causing computing device 600 to perform any one or more of the methodologies discussed herein may be executed. For example, instructions 602 include executable code that causes computing device 600 to execute method 300 and 400. In this way, these instructions transform the general, non-programmed machine into a particular machine programmed to carry out the described and illustrated functions in the manner described herein. Computing device 600 may operate as a standalone device or may be coupled (e.g., networked) to other machines.

By way of non-limiting example, computing device 600 may comprise or correspond to a television, a computer (e.g., a server computer, a client computer, a personal computer (PC), a tablet computer, a laptop computer, or a netbook), a set-top box (STB), a personal digital assistant (PDA), an entertainment media system (e.g., an audio/video receiver), a cellular telephone, a smart phone, a mobile device, a wearable device (e.g., a smart watch), a portable media player, or any machine capable of outputting audio signals and capable of executing instructions 602, sequentially or otherwise, that specify actions to be taken by computing device 600. Further, while only a single computing device 600 is illustrated, the term “machine” shall also be taken to include a collection of computing devices 600 that individually or jointly execute instructions 602 to perform any one or more of the methodologies discussed herein.

Computing device 600 may include processors 604, memory 606, storage unit 608 and I/O components 610, which may be configured to communicate with each other such as via bus 612. In an example embodiment, processors 604 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, processor 614 and processor 616 that may execute instructions 602. The term “processor” is intended to include multi-core processors that may comprise two or more independent processors (sometimes referred to as “cores”) that may execute instructions contemporaneously. Although FIG. 6 shows multiple processors, computing device 600 may include a single processor with a single core, a single processor with multiple cores (e.g., a multi-core process), multiple processors with a single core, multiple processors with multiples cores, or any combination thereof.

Memory 606 (e.g., a main memory or other memory storage) and storage unit 608 are both accessible to processors 604 such as via bus 612. Memory 606 and storage unit 608 store instructions 602 embodying any one or more of the methodologies or functions described herein. In some embodiments, database 616 resides on storage unit 608. Instructions 602 may also reside, completely or partially, within memory 606, within storage unit 608, within at least one of processors 604 (e.g., within the processor's cache memory), or any suitable combination thereof, during execution thereof by computing device 600. Accordingly, memory 606, storage unit 608, and the memory of processors 604 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), or any suitable combination thereof. The term “machine-readable medium” should be taken to include a single medium or multiple media (e.g., a centralized or distributed database, or associated caches and servers) able to store instructions 602. The term “machine-readable medium” shall also be taken to include any medium, or combination of multiple media, that is capable of storing instructions (e.g., instructions 602) for execution by a machine (e.g., computing device 600), such that the instructions, when executed by one or more processors of computing device 600 (e.g., processors 604), cause computing device 600 to perform any one or more of the methodologies described herein (e.g., method 300 and 400). Accordingly, a “machine-readable medium” refers to a single storage apparatus or device, as well as “cloud-based” storage systems or storage networks that include multiple storage apparatus or devices. The term “machine-readable medium” excludes signals per se.

Furthermore, the “machine-readable medium” is non-transitory in that it does not embody a propagating signal. However, labeling the tangible machine-readable medium as “non-transitory” should not be construed to mean that the medium is incapable of movement—the medium should be considered as being transportable from one real-world location to another. Additionally, since the machine-readable medium is tangible, the medium may be considered to be a machine-readable device.

The I/O components 610 may include a wide variety of components to receive input, provide output, produce output, transmit information, exchange information, capture measurements, and so on. The specific I/O components 610 that are included in a particular machine will depend on the type of machine. For example, portable machines such as mobile phones will likely include a touch input device or other such input mechanisms, while a headless server machine will likely not include such a touch input device. It will be appreciated that I/O components 610 may include many other components that are not specifically shown in FIG. 6. I/O components 610 are grouped according to functionality merely for simplifying the following discussion and the grouping is in no way limiting. In various example embodiments, I/O components 610 may include input components 618 and output components 620. Input components 618 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components, and the like. Output components 620 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth.

Communication may be implemented using a wide variety of technologies. I/O components 610 may include communication components 622 operable to couple computing device 600 to network 624 or devices 626 via coupling 628 and coupling 630, respectively. For example, communication components 622 may include a network interface component or other suitable device to interface with network 624. In further examples, communication components 622 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 626 may be another machine or any of a wide variety of peripheral devices (e.g., a peripheral device coupled via a Universal Serial Bus (USB)).

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Language

Although the embodiments of the present invention have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed is:

1. A method comprising:
determining, by a head-mounted viewing device, a first spatial location of a hardware controller relative to a spatial location of the head-mounted viewing device in a local environment;
determining, by the head-mounted viewing device, a second spatial location of the hardware controller relative to the position of the head-mounted viewing device in the local environment, the second spatial location being different than the first spatial location;
determining, based on at least the first spatial location and the second spatial location, a spatial boundary within the local environment relative to the spatial location of the head-mounted viewing device; and
causing presentation of a virtual content on a transparent display of the head-mounted viewing device based on the spatial boundary such that the virtual content appears to be present within the spatial boundary of the local environment to a user wearing the head-mounted viewing device.

2. The method of claim 1, wherein causing presentation of the virtual content on a transparent display of the head-mounted viewing device comprises:
determining, based on the spatial boundary, a presentation size of the virtual content;
determining based on the spatial boundary, a presentation position of the virtual content on display of the head-mounted viewing device;
generating the virtual content according to the presentation size; and
presenting the virtual content on the display of the head-mounted viewing device according to the presentation position.

3. The method of claim 1, further comprising:
detecting that the spatial location of the head-mounted viewing device has changed; and
updating presentation of the virtual content on the transparent display of the head-mounted viewing device such that the virtual content appears to remain present within the spatial boundary of the local environment to the user wearing the head-mounted viewing device.

4. The method of claim 3, wherein updating presentation of the virtual content comprises:
modifying one or more of a presentation size of the virtual content or a presentation position of the virtual content on the display of the head-mounted viewing device.

5. The method of claim 1, wherein determining the first spatial location of the hardware controller comprises:
receiving, from the hardware controller, location data gathered by sensors of the hardware controller;
determining the first spatial location of the hardware controller based on the location data received from the hardware controller.

6. The method of claim 1, wherein determining the first spatial location of the hardware controller comprises:
receiving an infrared signal transmitted by an infrared light-emitting diode (IR LED) located on the hardware controller; and
determining the first spatial location of the hardware controller based on the infrared signal.

7. The method of claim 1, further comprising:
after causing presentation of the virtual content on the transparent display of the head-mounted viewing device, receiving an input from the hardware controller indicating a direction in which to adjust presentation of the virtual content; and
updating presentation of the virtual content on the transparent display based on the received input.

8. A head-mounted viewing device comprising:
one or more computer processors; and
one or more computer-readable mediums storing instructions that, when executed by the one or more computer processors, cause the head-mounted viewing device to perform operations comprising:
determining a first spatial location of a hardware controller relative to a spatial location of the head-mounted viewing device in a local environment;
determining a second spatial location of the hardware controller relative to the position of the head-mounted viewing device in the local environment, the second spatial location being different than the first spatial location;
determining, based on at least the first spatial location and the second spatial location, a spatial boundary within the local environment relative to the spatial location of the head-mounted viewing device; and
causing presentation of a virtual content on a transparent display of the head-mounted viewing device based on the spatial boundary such that the virtual content appears to be present within the spatial boundary of the local environment to a user wearing the head-mounted viewing device.

9. The head-mounted viewing device of claim 8, wherein causing presentation of the virtual content on a transparent display of the head-mounted viewing device comprises:
determining, based on the spatial boundary, a presentation size of the virtual content;
determining based on the spatial boundary, a presentation position of the virtual content on display of the head-mounted viewing device;
generating the virtual content according to the presentation size; and
presenting the virtual content on the display of the head-mounted viewing device according to the presentation position.

10. The head-mounted viewing device of claim 8, the operations further comprising:
detecting that the spatial location of the head-mounted viewing device has changed; and
updating presentation of the virtual content on the transparent display of the head-mounted viewing device such that the virtual content appears to remain present within the spatial boundary of the local environment to the user wearing the head-mounted viewing device.

11. The head-mounted viewing device of claim 10, wherein updating presentation of the virtual content comprises:
modifying one or more of a presentation size of the virtual content or a presentation position of the virtual content on the display of the head-mounted viewing device.

12. The head-mounted viewing device of claim 8, wherein determining the first spatial location of the hardware controller comprises:
receiving, from the hardware controller, location data gathered by sensors of the hardware controller;
determining the first spatial location of the hardware controller based on the location data received from the hardware controller.

13. The head-mounted viewing device of claim 8, wherein determining the first spatial location of the hardware controller comprises:
receiving an infrared signal transmitted by an infrared light-emitting diode (IR LED) located on the hardware controller; and
determining the first spatial location of the hardware controller based on the infrared signal.

14. The head-mounted viewing device of claim 8, the operations further comprising:
after causing presentation of the virtual content on the transparent display of the head-mounted viewing device, receiving an input from the hardware controller indicating a direction in which to adjust presentation of the virtual content; and
updating presentation of the virtual content on the transparent display based on the received input.

15. A non-transitory computer-readable medium storing instructions that, when executed by one or more computer processors of a head-mounted viewing device, cause the head-mounted viewing device to perform operations comprising:
determining a first spatial location of a hardware controller relative to a spatial location of the head-mounted viewing device in a local environment;
determining a second spatial location of the hardware controller relative to the position of the head-mounted viewing device in the local environment, the second spatial location being different than the first spatial location;
determining, based on at least the first spatial location and the second spatial location, a spatial boundary within the local environment relative to the spatial location of the head-mounted viewing device; and
causing presentation of a virtual content on a transparent display of the head-mounted viewing device based on the spatial boundary such that the virtual content appears to be present within the spatial boundary of the local environment to a user wearing the head-mounted viewing device.

16. The non-transitory computer-readable medium of claim 15, wherein causing presentation of the virtual content on a transparent display of the head-mounted viewing device comprises:
determining, based on the spatial boundary, a presentation size of the virtual content;
determining based on the spatial boundary, a presentation position of the virtual content on display of the head-mounted viewing device;
generating the virtual content according to the presentation size; and
presenting the virtual content on the display of the head-mounted viewing device according to the presentation position.

17. The non-transitory computer-readable medium of claim 15, the operations further comprising:
detecting that the spatial location of the head-mounted viewing device has changed; and
updating presentation of the virtual content on the transparent display of the head-mounted viewing device such that the virtual content appears to remain present within the spatial boundary of the local environment to the user wearing the head-mounted viewing device.

18. The non-transitory computer-readable medium of claim 17, wherein updating presentation of the virtual content comprises:
modifying one or more of a presentation size of the virtual content or a presentation position of the virtual content on the display of the head-mounted viewing device.

19. The non-transitory computer-readable medium of claim 15, wherein determining the first spatial location of the hardware controller comprises:
receiving, from the hardware controller, location data gathered by sensors of the hardware controller;
determining the first spatial location of the hardware controller based on the location data received from the hardware controller.

20. The non-transitory computer-readable medium of claim 15, wherein determining the first spatial location of the hardware controller comprises:
receiving an infrared signal transmitted by an infrared light-emitting diode (IR LED) located on the hardware controller; and
determining the first spatial location of the hardware controller based on the infrared signal.
